(19) United States
(12) Patent Application Publication
(10) Pub. No.: US 2022/0407357 A1
(43) Pub. Date: Dec. 22, 2022

(54) CHARGING POWER CONTROL METHOD AND APPARATUS, AND READABLE STORAGE MEDIUM

(71) Applicant: Beijing Xiaomi Mobile Software Co., Ltd., Beijing (CN)

(72) Inventor: Yang LIU, Beijing (CN)

(73) Assignee: Beijing Xiaomi Mobile Software Co., Ltd., Beijing (CN)

(21) Appl. No.: 17/774,930

(22) PCT Filed: Nov. 7, 2019
(86) PCT No.: PCT/CN2019/116382

§ 371 Date: May 6, 2022

(51) Int. Cl. H02J 50/10; H02J 50/00; H02J 50/80

(52) U.S. Cl. CPC H02J 50/10; H02J 50/005; H02J 50/80

(57) ABSTRACT

A charging power control method, including: acquiring a heat dissipation parameter of a power-transmitting device, where the heat dissipation parameter is used for indicating the heat dissipation capacity of the power-transmitting device when charging a power-receiving device; acquiring a demand parameter of the power-receiving device, where the demand parameter is used for indicating the charging power demand of the power-receiving device; acquiring a target power control algorithm according to the heat dissipation parameter and the demand parameter; and according to the target power control algorithm, controlling the charging power at which the power-transmitting device charges the power-receiving device.

### CROSS-REFERENCE

The present application is a U.S. National Stage of International Application No. PCT/CN2019/116382, filed on Nov. 7, 2019, the contents of all of which are incorporated herein by reference in their entireties for all purposes.

### BACKGROUND

As the wireless charging technology develops, wireless charging is more convenient than traditional charging. As a result, the wireless charging technology has been applied to an increasing number of terminals.

### SUMMARY

The present disclosure relates to the technical field of wireless charging, and in particular to a charging power control method and apparatus, and a readable storage medium.

The present disclosure provides a charging power control method and apparatus, and a readable storage medium. The technical solution is as follows.

According to an aspect of examples of the present disclosure, a charging power control method is provided. The method includes:

acquiring a heat dissipation parameter of a power transmitting device, where the heat dissipation parameter is configured to indicate heat dissipation capacity when the power transmitting device charges a power receiving device;

acquiring a demand parameter of the power receiving device, where the demand parameter is configured to indicate a charging power demand of the power receiving device;

acquiring a target power control algorithm according to the heat dissipation parameter and the demand parameter; and

controlling charging power at which the power transmitting device charges the power receiving device according to the target power control algorithm.

According to an aspect of the examples of the present disclosure, a charging power control apparatus is provided. The apparatus includes:

a processor, and

a memory configured to store an executable instruction of the processor, where the processor is configured to:

acquire a heat dissipation parameter of a power transmitting device, where the heat dissipation parameter is configured to indicate heat dissipation capacity when the power transmitting device charges a power receiving device;

acquire a demand parameter of the power receiving device, where the demand parameter is configured to indicate a charging power demand of the power receiving device;

acquire a target power control algorithm according to the heat dissipation parameter and the demand parameter; and

control charging power at which according to the target power control algorithm, when the power transmitting device charges the power receiving device according to the target power control algorithm.

According to an aspect of the examples of the present disclosure, a non-transitory computer readable storage medium is provided. The non-transitory computer readable storage medium includes an executable instruction, where a processor in a terminal calls the executable instruction to implement the charging power control method according to the aspect or any one optional implementation mode of the aspect.

It is to be understood that the above general description and the following detailed description are merely examples, and cannot limit the present disclosure.

### BRIEF DESCRIPTION OF THE DRAWINGS

The accompanying drawings here, which are incorporated in the description as a constituent part of the present description, illustrate the examples satisfying the present disclosure and are configured to explain the principles of the present disclosure together with the description.

FIG. 1 is a structural schematic diagram of a wireless charging system provided in an example of the present disclosure.

FIG. 2 is a schematic diagram of a given curve involved in an example of the present disclosure.

FIG. 3 is a flow diagram of a charging power control method provided in an example of the present disclosure.

FIG. 4 is a flow diagram of a charging power control method provided in an example of the present disclosure.

FIG. 5 is a flow diagram of a charging power control method provided in an example of the present disclosure.

FIG. 6 is a block diagram of a charging power control apparatus according to an example.

FIG. 7 is a block diagram of an apparatus for executing a charging power control method according to an example.

### DETAILED DESCRIPTION

The examples will be described in detail here and shown in the accompanying drawings for example. When the following descriptions relate to the accompanying drawings, unless otherwise specified, the same numeral in different accompanying drawings denotes the same or similar element. The implementations described in the following examples do not denote all implementations consistent with the present disclosure. On the contrary, they are merely examples of an apparatus and a method consistent with some aspects of the present disclosure as detailed in the appended claims.

It is to be understood that as used here, “several” means one or more, and “a plurality of” means two or more. When describing an association relation of associated objects, “and/or” means that there may be three relations, for example, A and/or B, which may mean that A exists independently, A and B exist at the same time, or B exists independently. The character “/” generally means an “or” relation between two associated context objects. For convenience of understanding, some nouns and application scenes involved in the present disclosure are briefly introduced below.

In the related technology, when the terminal is charged wirelessly, a power transmitting device and a transmit-receive interface usually generate heat. The higher power transmitted by the power transmitting device, the longer a duration under high power, and the more heat generated by the power transmitting device. For example, power transmitted by some fast wireless power transmitting devices can reach 30 W to 45 W, which is expected to exceed 100 W in the next 1-2 years, resulting in overheat during charging.

The wireless charging technology is originated from the wireless power transmission technology, and may be divided into low-power wireless charging and high-power wireless charging. The low-power wireless charging usually uses electromagnetic induction, such as a wireless charging standard (Qi) mode for mobile phones, but some electric vehicles may also be charged wirelessly in an induction mode.

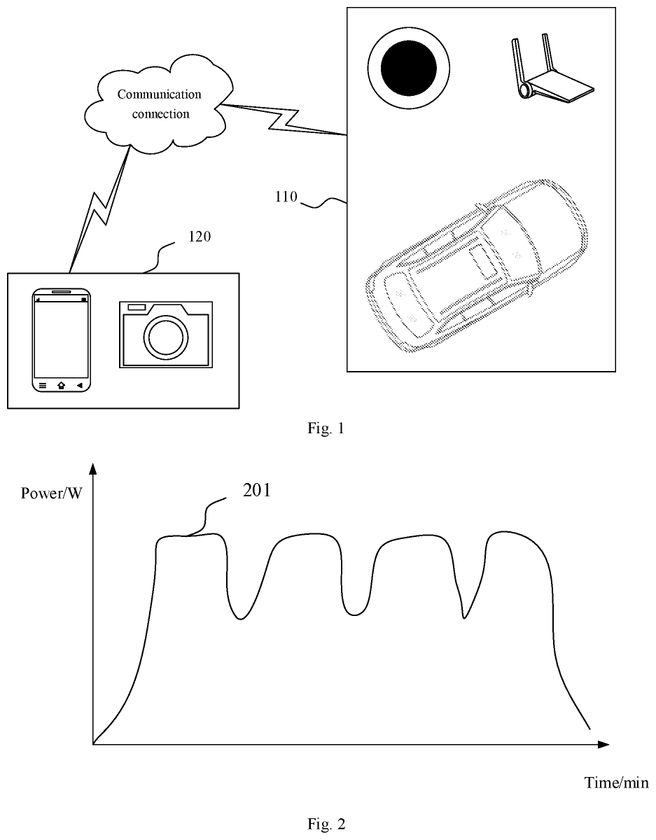

With reference to FIG. 1, a structural schematic diagram of a wireless charging system provided in an example of the present disclosure is shown. As shown in FIG. 1, the wireless charging system is a charging system based on electromagnetic induction or resonance, and the wireless charging system may include: a power transmitting device 110 and a power receiving device 120.

In one or more examples, the power transmitting device 110 may be a charging pile, a charger, a portable charger, etc. that supports wireless charging. The power transmitting device 110 may be connected to a power supply and transmits energy to provide energy. Alternatively, the power transmitting device 110 may also be a terminal device that supports wireless charging of other power receiving devices, such as a mobile phone and a router.

In one or more examples, the power receiving device 120 may be a terminal that supports wireless charging. For example, the power receiving device 120 may be a vehicle-mounted terminal, an unmanned aerial vehicle, a smart phone, a tablet computer, an e-book reader, smart glasses, a smart watch, a Moving Picture Experts Group Audio Layer III (MP3) player, a Moving Picture Experts Group Audio Layer IV (MP4) player, a notebook computer, a laptop computer, a desktop computer, etc.

In one or more examples, a communication connection may be further established between the power transmitting device 110 and the power receiving device 120 in the wireless charging system, and the communication connection may be a wired network or a wireless network.

In one or more examples, the wireless network or wired network uses a standard communication technology and/or a protocol. A network is usually the Internet or any network, including, but not limited to, any combination of a Local Area Network (LAN), a Metropolitan Area Network (MAN), a Wide Area Network (WAN), a mobile, wired or wireless network, a private network or a virtual private network. In some examples, technologies and/or formats including a Hyper Text Mark-up Language (HTML), an Extensible Markup Language (XML), etc. are configured to represent data exchanged through a network. In addition, conventional encryption technologies such as the Secure Socket Layer (SSL), Transport Layer Security (TLS), Virtual Private Network (VPN) and Internet Protocol Security (IPsec) may also be configured to encrypt all or some links. In some other examples, customized and/or private data communication technologies may also be used instead of or in addition to the data communication technologies.

In the wireless charging system, when the power transmitting device and the power receiving device are charged through electromagnetic field induction, the power transmitting device may generate heat, and the greater power provided by the power transmitting device, the more heat generated by the power transmitting device. The increase of wireless charging power used by mobile phones currently may cause transmission power of some power transmitting devices to reach 30 W to 45 W, which indicates that the power transmitting device may generate heat.

To improve safety of wireless charging and reduce heat generated by the power transmitting device during wireless charging, in related technologies, both the power transmitting device and the power receiving device may adjust their own temperatures. When a temperature rises to a certain threshold (for example, 60° C.), the power transmitting device may stop charging or use low-power charging, and then increases charging power after the temperature decreases. Most power transmitting devices achieve an effect of temperature reduction by arranging fans, so that the wireless charging power may be kept on a given curve. The given curve may describe change of power of the power transmitting device with time during charging. With reference to FIG. 2, a schematic diagram of a given curve involved in an example of the present disclosure is shown. As shown in FIG. 2, a first curve 201 is included, where a vertical axis represents transmission power of the power transmitting device, and a horizontal axis represents time. It may be seen from FIG. 2 that as time goes, the power transmitting device may adjust output power according to an own temperature.

However, due to design reasons, some power transmitting devices currently cannot be equipped with fans, such as a wireless portable charger (by considering a volume) or a charger integrated on surfaces of objects (such as a desktop and an armrest). As a result, the technical solution of controlling a temperature of the power transmitting device in the wireless charging system by arranging merely fans has limitations and low adaptability.

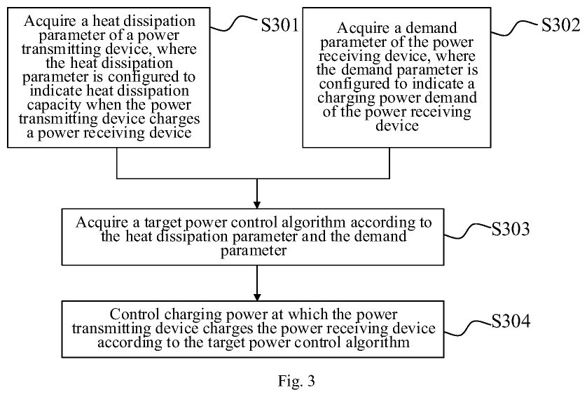

To increase adaptability of temperature control in the power transmitting device and improve accuracy of temperature control, the present disclosure provides a charging power control method. With reference to FIG. 3, a flow diagram of a charging power control method provided in an example of the present disclosure is shown. The method may be applied to the wireless charging system shown in FIG. 1, and is executed by a power transmitting device or a power receiving device in the system. As shown in FIG. 3, the charging power control method may include several steps as follows.

In S301, a heat dissipation parameter of the power transmitting device is acquired, where the heat dissipation parameter is configured to indicate heat dissipation capacity when the power transmitting device charges the power receiving device.

In S302, a demand parameter of the power receiving device is acquired, where the demand parameter is configured to indicate a charging power demand of the power receiving device.

In S303, a target power control algorithm is acquired according to the heat dissipation parameter and the demand parameter.

In S304, charging power at which the power transmitting device charges the power receiving device is controlled according to the target power control algorithm.

In one or more examples, the step of acquiring the target power control algorithm according to the heat dissipation parameter and the demand parameter includes the target power control algorithm is acquired from at least two power control algorithms according to the heat dissipation parameter and the demand parameter.

In one or more examples, before the target power control algorithm is acquired according to the heat dissipation parameter and the demand parameter, the method further includes first charging power at which the power transmitting device charges the power receiving device is acquired, where the first charging power is current charging power at which the power transmitting device charges the power receiving device; and alternatively, the first charging power is average charging power at which the power transmitting device charges the power receiving device in a specified time period before current time. Additionally, the method further includes a target power control algorithm is acquired according to the heat dissipation parameter and the demand parameter in response to determining that the first charging power is higher than a charging power threshold.

In one or more examples, the method is executed by the power transmitting device and further includes a communication connection with the power receiving device is established. The step of acquiring the demand parameter of the power receiving device includes the demand parameter transmitted from the power receiving device is received through the communication connection.

In one or more examples, the method is executed by the power receiving device and further includes a communication connection with the power transmitting device is established. The step of acquiring the heat dissipation parameter of the power transmitting device includes the heat dissipation parameter transmitted from the power transmitting device is received through the communication connection.

In one or more examples, the step of controlling charging power at which the power transmitting device charges the power receiving device according to the target power control algorithm includes second charging power in a next time period is acquired based on the target power control algorithm. The power transmitting device is requested to charge the power receiving device in the next time period according to the second charging power by transmitting a first power request to the power transmitting device through the communication connection, where the first power request includes the second charging power.

In one or more examples, the communication connection is any one of in-band communication or out-of-band communication.

In one or more examples, the heat dissipation parameter is a quantified coefficient value. Alternatively, the heat dissipation parameter is a heat dissipation type of the power transmitting device.

In conclusion, according to the present disclosure, the heat dissipation parameter of the power transmitting device is acquired, where the heat dissipation parameter is configured to indicate the heat dissipation capacity when the power transmitting device charges the power receiving device. The demand parameter of the power receiving device is acquired, where the demand parameter is configured to indicate the charging power demand of the power receiving device. The target power control algorithm is acquired according to the heat dissipation parameter and the demand parameter. The charging power at which the power transmitting device charges the power receiving device is controlled according to the target power control algorithm. According to the present disclosure, the target power control algorithm is acquired according to the heat dissipation parameter and the demand parameter, and the charging power transmitted from the power transmitting device may be adjusted according to a demand of the power receiving device. Thus, a temperature of the power transmitting device is controlled, and efficiency of charging the power receiving device is improved while the temperature of the power transmitting device is reduced, thus increasing application scenes of controlling the temperature of the power transmitting device.

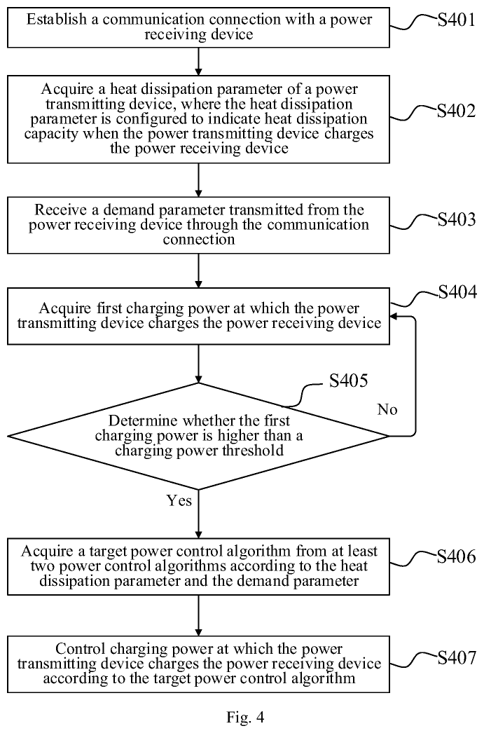

With reference to FIG. 4, a flow diagram of the charging power control method provided in an example of the present disclosure is shown. As shown in FIG. 4, the method may be applied to the wireless charging system shown in FIG. 1, and is executed by a power transmitting device in the system. As shown in FIG. 4, the charging power control method may include several steps as follows.

In S401, a communication connection with the power receiving device is established.

In one or more examples, in a process of charging the power receiving device, the power transmitting device may establish a communication connection with the power receiving device, so that the power transmitting device and the power receiving device may feed back charging conditions during charging to each other. In one or more examples, the communication connection between the power transmitting device and the power receiving device may be any one of in-band communication or out-of-band communication.

For example, a Bluetooth connection may be established between the power transmitting device and the power receiving device. The power transmitting device may transmit its own charging parameter to the power receiving device through the Bluetooth connection, and the power receiving device may also receive data transmitted from the power transmitting device. Accordingly, the power receiving device may also transmit its own charging parameter to the power transmitting device through the Bluetooth connection. In one or more examples, a Near Field Communication (NFC) connection may be established between the power transmitting device and the power receiving device, and the power transmitting device and the power receiving device may also transmit data to each other through the NFC connection.

In one or more examples, before the power transmitting device wirelessly charged the power receiving device, the power transmitting device may emit an electromagnetic pulse, and the electromagnetic pulse may be configured to detect the power receiving device that needs to be wirelessly charged. When the power receiving device is detected, the power transmitting device may charge the power receiving device. After the power transmitting device charges the power receiving device, the power transmitting device may establish the communication connection with the power receiving device. In one or more examples, the power transmitting device may also establish the communication connection with the power receiving device, then transmit an electromagnetic pulse to the power receiving device, detect the power receiving device, and charge the power receiving device after the power receiving device is detected, which is not limited by the examples of the present disclosure.

In a possible implementation mode, the power transmitting device may be a charger that supports wireless charging, and the power receiving device may be a mobile phone that supports wireless charging. A user may establish a Bluetooth connection between the mobile phone and the charger by turning on Bluetooth of each of the mobile phone and the charger, or if both the mobile phone and the charger support an NFC function, an NFC connection may also be established between the mobile phone and the charger. The power transmitting device may also be a vehicle-mounted terminal, a charger that supports wireless charging in the vehicle-mounted terminal provides a wireless charging function for the mobile phone, and accordingly, the power receiving device may be a mobile phone that supports wireless charging, which is not limited by the examples of the present disclosure.

In S402, a heat dissipation parameter of the power transmitting device is acquired, where the heat dissipation parameter is configured to indicate heat dissipation capacity when the power transmitting device charges a power receiving device.

The power transmitting device may acquire its own heat dissipation parameter before charging, and learns about its heat dissipation capacity when charging the power receiving device. In one or more examples, the heat dissipation parameter may be set in the power transmitting device in advance by a developer or operation and maintenance personnel. In one or more examples, the heat dissipation parameter is a quantified coefficient value; and alternatively, the heat dissipation parameter is a heat dissipation type of the power transmitting device.

In a possible implementation mode, the power transmitting device stores heat dissipation types in advance, such as a heat-dissipation-available type and a heat-dissipation-unavailable type. If the power transmitting device has a configuration capable of heat dissipation, the developer may set the heat dissipation parameter of the power transmitting device as the heat-dissipation-available type, and if the power transmitting device has no configuration capable of heat dissipation, the developer may set the heat dissipation parameter of the power transmitting device as the heat-dissipation-unavailable type. For example, if the power transmitting device is equipped with a fan for heat dissipation, the developer may set the heat dissipation parameter of the power transmitting device as the heat-dissipation-available type. Further, if the power transmitting device is not equipped with a fan for heat dissipation, the developer may set the heat dissipation parameter of the power transmitting device as the heat-dissipation-unavailable type.

In a possible implementation mode, the power transmitting device also stores a quantified coefficient value in advance, and the coefficient value may indicate the heat dissipation capacity of the power transmitting device. For example, the developer may divide the power transmitting device into a plurality of levels according to the heat dissipation capacity, and set a coefficient value corresponding to each level in the power transmitting device. With reference to Table 1, a heat dissipation coefficient table involved in an example of the present disclosure is shown.

TABLE 1

| Heat dissipation level | Heat dissipation coefficient |
|---|---|
| First level | 1 |
| Second level | 2 |
| Third level | 3 |
| . . . | . . . |

As shown in Table 1, a corresponding relation between a heat dissipation level and the heat dissipation coefficient is included. In the power transmitting device, its own heat dissipation coefficient may be preset. During wireless charging, a stored heat dissipation coefficient may be directly acquired when the heat dissipation parameter needs to be acquired.

In one or more examples, the power transmitting device may also transmit an acquired heat dissipation parameter to the power receiving device through the communication connection, so that the power receiving device may also learn about the heat dissipation parameter of the power transmitting device.

In S403, the demand parameter transmitted from the power receiving device is received through the communication connection.

The demand parameter is configured to indicate a charging power demand of the power receiving device. For example, the demand parameter may be a current battery electricity demand, full charging time, etc. of the power receiving device. In a possible implementation mode, the power receiving device may obtain the current battery electricity demand by acquiring its current battery electricity quantity and subtracting the current battery electricity quantity from a total battery electricity quantity. In a possible implementation mode, the power receiving device may be configured with time when a present electricity demand is fully satisfied, and the power receiving device may acquire the full charging time when the battery is to be fully charged according to current time. For example, the power receiving device may be configured with time when a present electricity demand is fully satisfied as 15 o'clock, and if the current time is 13 o'clock, the full charging time acquired by the power receiving device is two hours.

In one or more examples, the power receiving device may transmit an acquired demand parameter to the power transmitting device through the established communication connection, and accordingly the power transmitting device may receive the demand parameter transmitted from the power receiving device. The demand parameter may be acquired by the power receiving device before charging, or the demand parameter may also be acquired periodically or in real time by the power receiving device during charging, and fed back to the power transmitting device, which is not limited by the examples of the present disclosure.

It is to be noted that the order of S402 and S403 may also be exchanged or acquisition may be simultaneous, which is not limited by the examples of the present disclosure.

In S404, first charging power at which the power transmitting device charges the power receiving device is acquired.

The first charging power is current charging power at which the power transmitting device charges the power receiving device. Alternatively, the first charging power is average charging power at which the power transmitting device charges the power receiving device in a specified time period before current time.

For example, in a process of charging the power receiving device by the power transmitting device, the power transmitting device may acquire charging power transmitted from the power transmitting device to the power receiving device in real time, and acquired current charging power serves as first power. Alternatively, in the process of charging the power receiving device by the power transmitting device, the power transmitting device may also periodically acquire the charging power transmitted from the power transmitting device to the power receiving device, and acquired current charging power serves as the first power. Alternatively, in the process of charging the power receiving device by the power transmitting device, the power transmitting device may also periodically acquire average charging power of the charging power transmitted from the power transmitting device to the power receiving device in the period, and acquired average charging power serves as the first charging power.

In S405, whether the first charging power is higher than a charging power threshold is determined.

The charging power threshold may be set in the power transmitting device, and the power transmitting device may take the acquired first charging power as an application condition for executing subsequent steps of the examples of the present disclosure, where the step of acquiring the demand parameter of the power receiving device is executed in response to determining that the first charging power is higher than the charging power threshold, that is, S406 is entered. Otherwise, subsequent steps provided by the examples of the present disclosure are not executed, and S404 may be executed again. For example, the charging power threshold set in the power transmitting device is 15 W. When the first charging power acquired by the power transmitting device is higher than 15 W, the subsequent steps are executed. When the first charging power acquired by the power transmitting device is lower than 15 W, charging is still conducted at current charging power, and the first charging power at which the power transmitting device charges the power receiving device is continuously acquired.

In S406, the target power control algorithm is acquired from at least two power control algorithms according to the heat dissipation parameter and the demand parameter.

At least two power control algorithms may be set in the power transmitting device. Before transmitting the charging power, the power transmitting device may acquire one of the power control algorithms according to the heat dissipation parameter and the demand parameter, the power control algorithm serves as a generation algorithm of the current charging power and is the target power control algorithm.

In one or more examples, a corresponding relation table of the heat dissipation parameter, the demand parameter and the power control algorithm is set in the power transmitting device. With reference to Table 2, a corresponding relation table of the heat dissipation parameter, the demand parameter and the power control algorithm involved in an example of the present disclosure is shown.

TABLE 2

| Heat | Demand | Power |
|---|---|---|
| dissipation parameter | parameter range | control algorithm |
| First heat | First demand | First power |
| dissipation parameter | parameter range | control algorithm |
| First heat | Second demand | Second power |
| dissipation parameter | parameter range | control algorithm |
| Second heat | First demand | Third power |
| dissipation parameter | parameter range | control algorithm |
| Second heat | Second demand | Fourth power |
| dissipation parameter | parameter range | control algorithm |
| . . . | . . . | . . . |

As shown in Table 2, a power control algorithm corresponding to the heat dissipation parameter and a demand parameter range is included. The power transmitting device may determine the demand parameter range of the demand parameter according to a received demand parameter transmitted from the power receiving device, and acquire the power control algorithm in Table 2 according to the demand parameter range and its own heat dissipation parameter. For example, the power transmitting device determines the demand parameter range of the demand parameter to be a second demand parameter range according to the received demand parameter transmitted from the power receiving device, an own heat dissipation parameter acquired by the power transmitting device is a second heat dissipation parameter, and then the power transmitting device may learn that the target power control algorithm is a fourth power control algorithm according to Table 2.

In one or more examples, the power transmitting device may also acquire a temperature of the power transmitting device. In S405, a power control algorithm set in the power transmitting device may also be acquired by combining the temperature of the power transmitting device. With reference to Table 3, a corresponding relation including a power control algorithm involved in an example of the present disclosure is shown.

TABLE 3

| | Heat | Demand | Power |
|---|---|---|---|
| Temperature | dissipation | parameter | control |
| range | parameter | range | algorithm |
| First | First heat | First demand | First power |
| temperature | dissipation | parameter | control |
| range | parameter | range | algorithm |
| First | First heat | Second demand | Second power |
| temperature | dissipation | parameter | control |
| range | parameter | range | algorithm |
| First | Second heat | First demand | Third power |
| temperature | dissipation | parameter | control |
| range | parameter | range | algorithm |
| First | Second heat | Second demand | Fourth power |
| temperature | dissipation | parameter | control |
| range | parameter | range | algorithm |
| Second | First heat | First demand | Second power |
| temperature | dissipation | parameter | control |
| range | parameter | range | algorithm |
| Second | First heat | Second demand | Fourth power |
| temperature | dissipation | parameter | control |
| range | parameter | range | algorithm |
| Second | Second heat | First demand | First power |
| temperature | dissipation | parameter | control |
| range | parameter | range | algorithm |
| Second | Second heat | Second demand | Third power |
| temperature | dissipation | parameter | control |
| range | parameter | range | algorithm |
| . . . | . . . | . . . | . . . |

As shown in Table 3, a corresponding relation table of a temperature range, the heat dissipation parameter, the demand parameter and the power control algorithm is included. The power transmitting device may also acquire its own temperature to obtain a corresponding temperature range, and obtain a power control algorithm finally used with reference to Table 3. In one or more examples, a method through which the power transmitting device acquires its own temperature may also refer to a first charging power acquisition method. In addition, the power transmitting device may also transmit an acquired temperature to the power receiving device through the communication connection.

In one or more examples, the power receiving device may store power control algorithms consistent with at least two power control algorithms set in the power transmitting device, so that the power receiving device may also learn about a power control algorithm used by the power transmitting device when charging the power receiving device.

In S407, the charging power at which the power transmitting device charges the power receiving device is controlled according to the target power control algorithm.

In one or more examples, after the target power control algorithm is obtained, when the power transmitting device charges the power receiving device, charging power used by the power transmitting device is computed according to the target power control algorithm. For example, when the power transmitting device is going to charge the power receiving device at a first charging power, if the first charging power needs to be multiplied by a variation coefficient X in the acquired target power control algorithm, the power transmitting device may charge the power receiving device at X times of the first charging power in this case, thus achieving control and change of the charging power during charging of the power transmitting device.

In conclusion, according to the present disclosure, the heat dissipation parameter of the power transmitting device is acquired. The heat dissipation parameter is configured to indicate the heat dissipation capacity when the power transmitting device charges the power receiving device. The demand parameter of the power receiving device is acquired, where the demand parameter is configured to indicate the charging power demand of the power receiving device. The target power control algorithm is acquired according to the heat dissipation parameter and the demand parameter. The charging power at which the power transmitting device charges the power receiving device is controlled according to the target power control algorithm. According to the present disclosure, the target power control algorithm is acquired according to the heat dissipation parameter and the demand parameter, and the charging power transmitted from the power transmitting device may be adjusted according to a demand of the power receiving device, so that the temperature of the power transmitting device is controlled, and efficiency of charging the power receiving device is improved while the temperature of the power transmitting device is reduced, thus increasing application scenes of controlling the temperature of the power transmitting device.

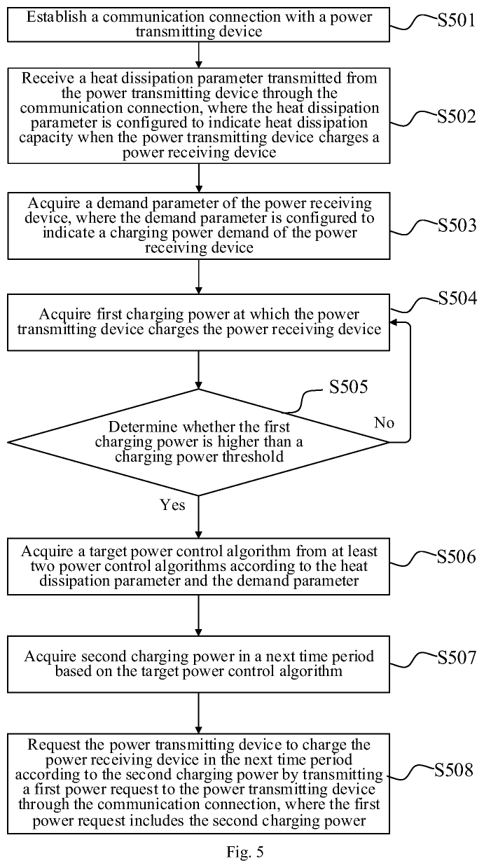

With reference to FIG. 5, a flow diagram of the charging power control method provided in an example of the present disclosure is shown. As shown in FIG. 5, the method may be applied to the wireless charging system shown in FIG. 1, and is executed by a power receiving device in the system. As shown in FIG. 5, the charging power control method may include several steps as follows.

In S501, a communication connection with the power transmitting device is established. Establishing the communication connection in the step may refer to the description in S401, which is not repeated here.

In S502, a heat dissipation parameter transmitted from the power transmitting device is received through the communication connection, where the heat dissipation parameter is configured to indicate heat dissipation capacity when the power transmitting device charges the power receiving device.

In one or more examples, the power transmitting device may acquire its own heat dissipation parameter, and transmit the heat dissipation parameter to the power receiving device through the communication connection. A method through which the power transmitting device acquires its own heat dissipation parameter may refer to the description in S402, which is not repeated here. In a possible implementation mode, the power receiving device may also transmit a heat dissipation parameter acquisition request through a communication connection, and requests a heat dissipation parameter from the power transmitting device through the heat dissipation parameter acquisition request. Accordingly, the power transmitting device may transmit the heat dissipation parameter to the power receiving device after receiving the heat dissipation parameter acquisition request transmitted from the power receiving device.

In S503, a demand parameter of the power receiving device is acquired, where the demand parameter is configured to indicate a charging power demand of the power receiving device. The power receiving device may acquire its own demand parameter. In one or more examples, the demand parameter and a method through which the power receiving device acquires its own demand parameter may refer to the description in S403, which is not repeated here.

In S504, first charging power at which the power transmitting device charges the power receiving device is acquired.

The first charging power is current charging power at which the power transmitting device charges the power receiving device. Alternatively, the first charging power is average charging power at which the power transmitting device charges the power receiving device in a specified time period before current time. In one or more examples, the power receiving device may acquire the first charging power by acquiring the power by the power transmitting device and transmitting the power to the power receiving device through the communication connection. A method through which the power transmitting device acquires its own first charging power may also refer to the description in S404, which is not repeated here.

In S505, whether the first charging power is higher than a charging power threshold is determined.

Similarly, the power receiving device may also take acquired first charging power as an application condition for executing subsequent steps of the example of the present disclosure. The step of acquiring the demand parameter of the power receiving device is executed in response to determining that the first charging power is higher than the charging power threshold, that is, S506 is entered. Otherwise, subsequent steps provided by the example of the present disclosure are not executed, and S504 is executed continuously, which may also refer to the description in S405 and is not repeated here.

In S506, a target power control algorithm is acquired from at least two power control algorithms according to the heat dissipation parameter and the demand parameter. A method through which the power receiving device acquires the target power control algorithm may also refer to the description in S406, which is not repeated here.

In S507, second charging power in a next time period is acquired based on the target power control algorithm.

In one or more examples, after obtaining the target power control algorithm, the power receiving device may acquire the second charging power needed by the power receiving device according to the target power control algorithm. For example, charging power employed when a current power transmitting device charges the power receiving device is the first charging power, and then the power receiving device learns that charging power that the power transmitting device needs to provide in this case is a second charging power according to the steps, which indicates that the power receiving device needs to be charged by the power transmitting device at the second charging power in the next time period. In a possible implementation mode, the target power control algorithm multiplies current power by a certain coefficient Y. When the power receiving device acquires the second charging power according to the target power control algorithm, the current charging power transmitted from the current power transmitting device may be multiplied by the coefficient Y, so as to obtain the second charging power.

In S508, the power transmitting device is requested to charge the power receiving device in the next time period according to the second charging power by transmitting a first power request to the power transmitting device through the communication connection, where the first power request includes the second charging power.

In one or more examples, the power receiving device may generate the first power request, the first power request may carry the second charging power obtained above, and then the power transmitting device is requested to charge the power receiving device in the next time period according to the second charging power by transmitting the first power request to the power transmitting device. After receiving the first power request transmitted from the power receiving device, the power transmitting device may acquire the second charging power, adjust its own charging power to the second charging power, indirectly change a temperature of the power transmitting device by adjusting the charging power in a subsequent charging process, and conduct charging according to a request of the power receiving device and corresponding charging power, and may also improve efficiency of charging the power receiving device.

It is to be noted that in practical application, the solutions shown in FIG. 4 and FIG. 5 may also be combined with each other. In a process of charging the power receiving device, the power receiving device and the power transmitting device feed back data needed by each other through the communication connection, so as to adjust the charging power of the power transmitting device, reduce the temperature of the power transmitting device and improve the efficiency of charging the power receiving device.

In one or more examples, there may be a plurality of power receiving devices. For example, a power transmitting device may charge a plurality of power receiving devices at the same time, and charging power control between the power transmitting device and each of the power receiving devices may also be executed according to the solution shown in FIG. 4 or 5, which is not limited by the example of the present disclosure.

In conclusion, according to the present disclosure, the heat dissipation parameter of the power transmitting device is acquired. The heat dissipation parameter is configured to indicate the heat dissipation capacity when the power transmitting device charges the power receiving device. The demand parameter of the power receiving device is acquired, where the demand parameter is configured to indicate the charging power demand of the power receiving device. The target power control algorithm is acquired according to the heat dissipation parameter and the demand parameter. The charging power at which the power transmitting device charges the power receiving device is controlled according to the target power control algorithm. According to the present disclosure, the target power control algorithm is acquired according to the heat dissipation parameter and the demand parameter, and the charging power transmitted from the power transmitting device may be adjusted according to a demand of the power receiving device, so that the temperature of the power transmitting device is controlled, and efficiency of charging the power receiving device is improved while the temperature of the power transmitting device is reduced, thus increasing application scenes of controlling the temperature of the power transmitting device.

The following is examples of an apparatus of the present disclosure, which may be used for executing the examples of the method of the present disclosure. For details not disclosed in the examples of the apparatus of the present disclosure, please refer to the examples of the method of the present disclosure.

FIG. 6 is a block diagram of a charging power control apparatus shown in an example. As shown in FIG. 6, the charging power control apparatus may be implemented as the whole or part of a target terminal in an implementation environment shown in FIG. 1 in a mode of hardware or a combination of the hardware and software, so as to execute steps, executed by a power transmitting device or a power receiving device, in any one example in FIG. 2, 4 or 5.

The charging power control apparatus may include a heat dissipation parameter acquisition module 601 configured to acquire a heat dissipation parameter of the power transmitting device, where the heat dissipation parameter is configured to indicate heat dissipation capacity when the power transmitting device charges the power receiving device. A demand parameter acquisition module 602 configured to acquire a demand parameter of the power receiving device, where the demand parameter is configured to indicate a charging power demand of the power receiving device. A target algorithm acquisition module 603 configured to acquire a target power control algorithm according to the heat dissipation parameter and the demand parameter. Additionally, the charging power control apparatus may include a charging power control module 604 configured to control charging power at which the power transmitting device charges the power receiving device according to the target power control algorithm.

In one or more examples, the target algorithm acquisition module 603 is configured to acquire the target power control algorithm from at least two power control algorithms according to the heat dissipation parameter and the demand parameter.

In one or more examples, the apparatus further includes: a power acquisition module and a first execution module. The power acquisition module is configured to acquire, before the target algorithm acquisition module 603 acquires the target power control algorithm according to the heat dissipation parameter and the demand parameter, first charging power at which the power transmitting device charges the power receiving device. Where the first charging power is current charging power at which the power transmitting device charges the power receiving device. Alternatively, the first charging power is average charging power at which the power transmitting device charges the power receiving device in a specified time period before current time. The first execution module is configured to execute, in response to determining that the first charging power is higher than a charging power threshold, the step of acquiring the target power control algorithm according to the heat dissipation parameter and the demand parameter.

In one or more examples, the apparatus is executed by the power transmitting device and further includes a first connection establishing module configured to establish a communication connection with the power receiving device. The demand parameter acquisition module 602 is configured to receive the demand parameter transmitted from the power receiving device through the communication connection.

In one or more examples, the apparatus is executed by the power receiving device and further includes a second connection establishing module configured to establish a communication connection with the power transmitting device. The heat dissipation parameter acquisition module 601 is configured to receive the heat dissipation parameter transmitted from the power transmitting device through the communication connection.

In one or more examples, the charging power control module 604 includes: a power acquisition unit and a request transmission unit. The power acquisition unit is configured to acquire second charging power in a next time period based on the target power control algorithm. The request transmission unit is configured to request the power transmitting device to charge the power receiving device in the next time period according to the second charging power by transmitting a first power request to the power transmitting device through the communication connection, where the first power request includes the second charging power.

In one or more examples, the communication connection is any one of in-band communication or out-of-band communication.

In one or more examples, the heat dissipation parameter is a quantified coefficient value. Alternatively, the heat dissipation parameter is a heat dissipation type of the power transmitting device.

It is to be noted that the apparatus provided in the examples is illustrated only with the functional modules divided when implementing functions. In actual application, the functions may be implemented by different functional modules according to actual demand, that is, a content structure of a device is divided into different functional modules, so as to implement all or some of the functions described above.

For the apparatus in the examples described above, a specific method for each module to execute an operation has been described in detail in the examples relating to the method, and will not be repeated here.

An example of the present disclosure provides a charging power control apparatus. The apparatus may implement all or some of steps, executed by a power transmitting device or a power receiving device, in the examples in FIG. 2, 4 or 5 of the present disclosure. The charging power control apparatus includes: a processor and a memory configured to store an executable instruction of the processor. The processor is configured to acquire a heat dissipation parameter of the power transmitting device, where the heat dissipation parameter is configured to indicate heat dissipation capacity when the power transmitting device charges the power receiving device. Acquire a demand parameter of the power receiving device, where the demand parameter is configured to indicate a charging power demand of the power receiving device. The processor is further configured to acquire a target power control algorithm according to the heat dissipation parameter and the demand parameter and control charging power at which the power transmitting device charges the power receiving device according to the target power control algorithm.

In one or more examples, in the step of acquiring the target power control algorithm according to the heat dissipation parameter and the demand parameter, the processor is configured to acquire the target power control algorithm from at least two power control algorithms according to the heat dissipation parameter and the demand parameter.

In one or more examples, the processor is further configured to acquire, before acquiring the target power control algorithm according to the heat dissipation parameter and the demand parameter, first charging power at which the power transmitting device charges the power receiving device. The first charging power is current charging power at which the power transmitting device charges the power receiving device; and alternatively, the first charging power is average charging power at which the power transmitting device charges the power receiving device in a specified time period before current time. The processor is further configured to execute, in response to determining that the first charging power is higher than a charging power threshold, the step of acquiring the target power control algorithm according to the heat dissipation parameter and the demand parameter.

In one or more examples, the method is executed by the power transmitting device, and the processor is further configured to establish a communication connection with the power receiving device. The step of acquiring a demand parameter of the power receiving device includes the demand parameter transmitted from the power receiving device is received through the communication connection.

In one or more examples, the method is executed by the power receiving device, and the processor is further configured to establish a communication connection with the power transmitting device. The step of acquiring a heat dissipation parameter of the power transmitting device includes the heat dissipation parameter transmitted from the power transmitting device is received through the communication connection.

In one or more examples, in the step of controlling charging power at which the power transmitting device charges the power receiving device according to the target power control algorithm. The processor is configured to acquire second charging power in a next time period based on the target power control algorithm and request the power transmitting device to charge the power receiving device in the next time period according to the second charging power by transmitting a first power request to the power transmitting device through the communication connection, where the first power request includes the second charging power.

In one or more examples, the communication connection is any one of in-band communication or out-of-band communication.

In one or more examples, the heat dissipation parameter is a quantified coefficient value. Alternatively, the heat dissipation parameter is a heat dissipation type of the power transmitting device.

The solution provided in the example of the present disclosure is described as above mainly with the power transmitting device and the power receiving device as examples. It may be understood that in order to implement the functions, the power transmitting device or the power receiving device includes corresponding hardware structures and/or software modules executing all the functions. By combining modules and algorithm steps of all the examples described in the examples disclosed in the present disclosure, the examples of the present disclosure may be implemented in a mode of hardware or a combination of hardware and computer software. Whether some function is executed in a mode of hardware or a mode of driving hardware by computer software depends on a specific application and design constraints of the technical solution. Those skilled in the art may use different methods to implement the functions described above for each particular application, but such implementation is not considered to be beyond the scope of the technical solution of the examples of the present disclosure.

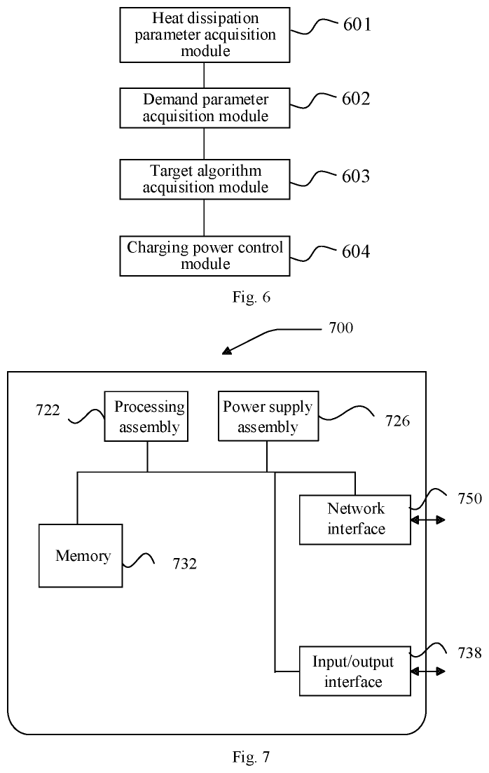

FIG. 7 is a block diagram of an apparatus for executing a charging power control method according to an example. An apparatus 700 may be provided as a power transmitting device or a power receiving device. As shown in FIG. 7, the apparatus 700 includes a processing assembly 722, and further includes one or more processors, and a memory resource represented by a memory 732 that is configured to store instructions executable by the processing assembly 722, such as applications. The applications stored in the memory 732 may include one or more modules of which each corresponds to a group of instructions. In addition, the processing assembly 722 is configured to execute instructions so as to execute all or some of steps, executed by the power transmitting device or the power receiving device, in the short message display method.

The apparatus 700 may further include a power supply assembly 726 configured to conduct power management of the apparatus 700, a wired or wireless network interface 750 configured to connect the apparatus 700 to a network, and an input/output (I/O) interface 738. The apparatus 700 may operate based on an operating system stored in the memory 732, such as Windows Server™, Mac OS X™, Unix™, Linux™ and FreeBSD™.

Those skilled in the art may recognize that in the above one or more examples, the functions described in the examples of the present disclosure may be implemented through hardware, software, firmware or any of their combinations. When being implemented through software, the functions may be stored in a computer readable storage medium or serve as one or more instructions or codes on a computer readable medium to be transmitted. The computer readable medium includes a computer storage medium and a communication medium, where the communication medium includes any medium facilitating transfer of a computer program from one place to another place. The storage medium may be any usable medium capable of being stored and accessed by a general-purpose or dedicated-purpose computer.

The example of the present disclosure further provides a computer storage medium, which is configured to store a computer software instruction used by the base station. The computer software instruction includes a program designed for executing the charging power control method.

The example of the present disclosure further provides a computer storage medium, which is configured to store a computer software instruction used by the terminal. The computer software instruction includes a program designed for executing the charging power control method.

Those skilled in the art could easily conceive of other implementation solutions of the present disclosure upon consideration of the description and the invention disclosed in the implementation. The present disclosure is intended to cover any variations, uses or adaptive changes of the present disclosure, which follow the general principles of the present disclosure and include common general knowledge or conventional technical means, not disclosed in the present disclosure, in the art. The description and the examples are to be regarded as mere examples, and the true scope and spirit of the present disclosure are indicated by the following claims.

It is to be understood that the present disclosure is not limited to a precise structure which has been described above and illustrated in the accompanying drawings, and may have various modifications and changes without departing from the scope. The scope of the present disclosure is limited merely by the appended claims.

Additional non-limiting embodiments of the disclosure include:

1. A charging power control method, including:

acquiring a heat dissipation parameter of a power transmitting device, where the heat dissipation parameter is configured to indicate heat dissipation capacity when the power transmitting device charges a power receiving device;

acquiring a demand parameter of the power receiving device, where the demand parameter is configured to indicate a charging power demand of the power receiving device;

acquiring a target power control algorithm according to the heat dissipation parameter and the demand parameter; and

controlling charging power at which the power transmitting device charges the power receiving device according to the target power control algorithm.

2. The method according to embodiment 1, where acquiring the target power control algorithm according to the heat dissipation parameter and the demand parameter includes:

acquiring the target power control algorithm from at least two power control algorithms according to the heat dissipation parameter and the demand parameter.

3. The method according to embodiment 1 or 2, where before acquiring a target power control algorithm according to the heat dissipation parameter and the demand parameter, the method further includes:

acquiring first charging power at which the power transmitting device charges the power receiving device, where the first charging power is current charging power at which the power transmitting device charges the power receiving device, and alternatively, the first charging power is average charging power at which the power transmitting device charges the power receiving device in a specified time period before current time; and

in response to determining that the first charging power is higher than a charging power threshold, executing a step of acquiring the target power control algorithm according to the heat dissipation parameter and the demand parameter.

4. The method according to any one of embodiments 1-3, where the method is executed by the power transmitting device and further includes:

establishing a communication connection with the power receiving device, where

acquiring the demand parameter of the power receiving device includes:

receiving the demand parameter transmitted from the power receiving device through the communication connection.

5. The method according to any one of embodiments 1-3, where the method is executed by the power receiving device and further includes:

establishing a communication connection with the power transmitting device, where

acquiring the heat dissipation parameter of the power transmitting device includes:

receiving the heat dissipation parameter transmitted from the power transmitting device through the communication connection.

6. The method according to embodiment 5, where controlling charging power at which the power transmitting device charges the power receiving device according to the target power control algorithm includes:

acquiring second charging power in a next time period based on the target power control algorithm; and

requesting the power transmitting device to charge the power receiving device in the next time period according to the second charging power by transmitting a first power request to the power transmitting device through the communication connection, where the first power request includes the second charging power.

7. The method according to embodiment 4 or 5, where the communication connection is any one of in-band communication or out-of-band communication.

8. The method according to any one of embodiments 1-7, where the heat dissipation parameter is a quantified coefficient value; and

alternatively,

the heat dissipation parameter is a heat dissipation type of the power transmitting device.

9. A charging power control apparatus, including:

a heat dissipation parameter acquisition module configured to acquire a heat dissipation parameter of a power transmitting device, where the heat dissipation parameter is configured to indicate heat dissipation capacity when the power transmitting device charges a power receiving device;

a demand parameter acquisition module configured to acquire a demand parameter of the power receiving device, where the demand parameter is configured to indicate a charging power demand of the power receiving device;

a target algorithm acquisition module configured to acquire a target power control algorithm according to the heat dissipation parameter and the demand parameter; and

a charging power control module configured to control charging power at which the power transmitting device charges the power receiving device according to the target power control algorithm.

10. The apparatus according to embodiment 9, where the target algorithm acquisition module is configured to:

acquire the target power control algorithm from at least two power control algorithms according to the heat dissipation parameter and the demand parameter.

11. The apparatus according to embodiment 9 or 10, further including: a power acquisition module and a first execution module, where

the power acquisition module is configured to acquire, before the target algorithm acquisition module acquires the target power control algorithm according to the heat dissipation parameter and the demand parameter, first charging power at which the power transmitting device charges the power receiving device, where the first charging power is current charging power at which the power transmitting device charges the power receiving device, and alternatively, the first charging power is average charging power at which the power transmitting device charges the power receiving device in a specified time period before current time; and

the first execution module is configured to execute, in response to determining that the first charging power is higher than a charging power threshold, a step of acquiring the target power control algorithm according to the heat dissipation parameter and the demand parameter.

12. The apparatus according to any one of embodiments 9-11, where the apparatus is executed by the power transmitting device and further includes:

a first connection establishing module configured to establish a communication connection with the power receiving device, where

the demand parameter acquisition module is configured to receive the demand parameter transmitted from the power receiving device through the communication connection.

13. The apparatus according to any one of embodiments 9-11, where the apparatus is executed by the power receiving device and further includes:

a second connection establishing module configured to establish a communication connection with the power transmitting device, where

the heat dissipation parameter acquisition module is configured to receive the heat dissipation parameter transmitted from the power transmitting device through the communication connection.

14. The apparatus according to embodiment 13, where the charging power control module includes: a power acquisition unit and a request transmission unit;

the power acquisition unit is configured to acquire second charging power in a next time period based on the target power control algorithm; and

the request transmission unit is configured to request the power transmitting device to charge the power receiving device in the next time period according to the second charging power by transmitting a first power request to the power transmitting device through the communication connection, where the first power request includes the second charging power.

15. The apparatus according to embodiment 12 or 13, where the communication connection is any one of in-band communication or out-of-band communication.

16. The apparatus according to any one of embodiments 9-15, where

the heat dissipation parameter is a quantified coefficient value; and

alternatively,

the heat dissipation parameter is a heat dissipation type of the power transmitting device.

17. A charging power control apparatus, including:

a processor, and

a memory configured to store an executable instruction of the processor,

where the processor is configured to:

acquire a heat dissipation parameter of a power transmitting device, where the heat dissipation parameter is configured to indicate heat dissipation capacity when the power transmitting device charges a power receiving device;

acquire a demand parameter of the power receiving device, where the demand parameter is configured to indicate a charging power demand of the power receiving device;

acquire a target power control algorithm according to the heat dissipation parameter and the demand parameter; and

control charging power at which the power transmitting device charges the power receiving device according to the target power control algorithm.

18. A non-transitory computer readable storage medium, including an executable instruction, where a processor in a terminal calls the executable instruction to implement the charging power control method according to any one of the embodiments 1-8.

1. A charging power control method, comprising:
acquiring a heat dissipation parameter of a power transmitting device, wherein the heat dissipation parameter is configured to indicate heat dissipation capacity when the power transmitting device charges a power receiving device;
acquiring a demand parameter of the power receiving device, wherein the demand parameter is configured to indicate a charging power demand of the power receiving device;
acquiring a target power control algorithm according to the heat dissipation parameter and the demand parameter; and
controlling charging power at which the power transmitting device charges the power receiving device according to the target power control algorithm.

2. The method according to claim 1, wherein acquiring the target power control algorithm according to the heat dissipation parameter and the demand parameter comprises:
acquiring the target power control algorithm from at least two power control algorithms according to the heat dissipation parameter and the demand parameter.

3. The method according to claim 1, wherein the method further comprises:
acquiring first charging power at which the power transmitting device charges the power receiving device, wherein the first charging power is one of a current charging power at which the power transmitting device charges the power receiving device, and an average charging power at which the power transmitting device charges the power receiving device in a specified time period before current time; and
in response to determining that the first charging power is higher than a charging power threshold, executing a step of acquiring the target power control algorithm according to the heat dissipation parameter and the demand parameter.

4. The method according to claim 1, wherein the method is executed by the power transmitting device and further comprises:
establishing a communication connection with the power receiving device, wherein
acquiring the demand parameter of the power receiving device comprises:
receiving the demand parameter transmitted from the power receiving device through the communication connection.

5. The method according to claim 1, wherein the method is executed by the power receiving device and further comprises:
establishing a communication connection with the power transmitting device, wherein
acquiring the heat dissipation parameter of the power transmitting device comprises:
receiving the heat dissipation parameter transmitted from the power transmitting device through the communication connection.

6. The method according to claim 5, wherein controlling charging power at which the power transmitting device charges the power receiving device according to the target power control algorithm comprises:
acquiring second charging power in a next time period based on the target power control algorithm; and
requesting the power transmitting device to charge the power receiving device in the next time period according to the second charging power by transmitting a first power request to the power transmitting device through the communication connection, wherein the first power request comprises the second charging power.

7. The method according to claim 4, wherein the communication connection is any one of in-band communication or out-of-band communication.

8. The method according to claim 1, wherein
the heat dissipation parameter is one of a quantified coefficient value; and
a heat dissipation type of the power transmitting device.

9-16. (canceled)

17. A charging power control apparatus, comprising:
a processor, and
a memory configured to store an executable instruction of the processor,
wherein the processor is configured to:
acquire a heat dissipation parameter of a power transmitting device, wherein the heat dissipation parameter is configured to indicate heat dissipation capacity when the power transmitting device charges a power receiving device;
acquire a demand parameter of the power receiving device, wherein the demand parameter is configured to indicate a charging power demand of the power receiving device;
acquire a target power control algorithm according to the heat dissipation parameter and the demand parameter; and
control charging power at which the power transmitting device charges the power receiving device according to the target power control algorithm.

18. A non-transitory computer readable storage medium, comprising an executable instruction, wherein a processor in a terminal calls the executable instruction to implement;
acquiring a heat dissipation parameter of a power transmitting device, wherein the heat dissipation parameter is configured to indicate heat dissipation capacity when the power transmitting device charges a power receiving device;
acquiring a demand parameter of the power receiving device, wherein the demand parameter is configured to indicate a charging power demand of the power receiving device;
acquiring a target power control algorithm according to the heat dissipation parameter and the demand parameter; and
controlling charging power at which the power transmitting device charges the power receiving device according to the target power control algorithm.

19. The method according to claim 5, wherein the communication connection is any one of in-band communication or out-of-band communication.

20. The apparatus according to claim 17, wherein the processor is configured to:
acquire the target power control algorithm from at least two power control algorithms according to the heat dissipation parameter and the demand parameter.

21. The apparatus according to claim 17, wherein the processor is further configured to:
acquire first charging power at which the power transmitting device charges the power receiving device, wherein the first charging power is one of a current charging power at which the power transmitting device charges the power receiving device, and an average charging power at which the power transmitting device charges the power receiving device in a specified time period before current time; and
execute, in response to determining that the first charging power is higher than a charging power threshold, a step of acquiring the target power control algorithm according to the heat dissipation parameter and the demand parameter.

22. The apparatus according to claim 17, wherein the apparatus is configured for the power transmitting device, the processor is further configured to:
establish a communication connection with the power receiving device, wherein
the processor is further configured to: acquiring the demand parameter of the power receiving device by receiving the demand parameter transmitted from the power receiving device through the communication connection.

23. The apparatus according to claim 17, wherein the apparatus is configured for the power receiving device, the processor is further configured to:
establish a communication connection with the power transmitting device, wherein
the processor is further configured to: acquiring the heat dissipation parameter of the power transmitting device by receiving the heat dissipation parameter transmitted from the power transmitting device through the communication connection.

24. The apparatus according to claim 23, wherein the processor is configured to:
acquire second charging power in a next time period based on the target power control algorithm; and
request the power transmitting device to charge the power receiving device in the next time period according to the second charging power by transmitting a first power request to the power transmitting device through the communication connection, wherein the first power request comprises the second charging power.

25. The apparatus according to claim 22, wherein the communication connection is any one of in-band communication or out-of-band communication.

26. The apparatus according to claim 23, wherein the communication connection is any one of in-band communication or out-of-band communication.

27. The apparatus according to claim 17, wherein
the heat dissipation parameter is one of a quantified coefficient value and a heat dissipation type of the power transmitting device.
